(19) United States
(12) Patent Application Publication
(10) Pub. No.: US 2002/0105592 A1
(43) Pub. Date: Aug. 8, 2002

(54) System and method for processing HDTV format video signals

(75) Inventors: Benjamin E. Felts III, Cardiff, CA (US); Asif Shakeel, San Diego, CA (US); Dennis L. Poltz, San Diego, CA (US); Semion Talpalatsky, San Diego, CA (US)

Correspondence Address: FARJAMI & FARJAMI LLP, 16148 Sand Canyon, Irvine, CA, 92618, US

(73) Assignee: Conexant Systems, Inc.

(21) Appl. No.: 09/777,253

(22) Filed: Feb. 5, 2001

(51) Int. Cl. H04N 3/27; H04N 7/16

(52) U.S. Cl. 348/554; 348/521

(57) ABSTRACT

System and method for processing HDTV format video signals have been disclosed. A disclosed embodiment comprises a HDTV timing generator having as inputs a vertical sync and a horizontal sync. The HDTV timing generator outputs a digital HD level signal. The disclosed embodiment further comprises a DAC interface. The DAC interface can include an encoder channel, or more than one encoder channel. The encoder channel can receive a digital HD level signal, a SCART level signal, an NTSC level signal, a PAL level signal, and a SECAM level signal. The encoder channel can further receive a HDTV format data input, a SCART format data input, an NTSC format data input, a PAL format data input, and a SECAM format data input. The output of the DAC interface can be coupled to a DAC which in turn generates an output suitable for display on a monitor.

### BACKGROUND OF THE INVENTION

1. Field of the Invention

The present invention is generally in the field of processing video signals. More specifically, the present invention is in the field of processing HDTV format video signals and displaying the processed video signals on a monitor.

2. Background Art

There has been a growing consumer demand for a higher quality TV picture—a picture that is more true-to-life. This demand has been fueled in part by the continuing increase in image quality and resolution that is available from the display monitor of the personal computer. These continuing advances in image quality and resolution in computer displays have been made possible by the early establishment of standards for the generation of the signals that drive the computer display monitors. However, in the consumer TV market, High-Definition Television (HDTV) has only recently emerged as an alternative to the conventional TV due to a long battle over industry acceptance of any standards that define the signals and data format that HDTV requires. In HDTV, the resolution of the TV image is much higher, and the colors more accurate than the images produced by existing TV formats such as National Television System Committee (“NTSC”), Phase Alternate Line (“PAL”), and Sequential Color and Memory (“SECAM”). Desktop PCs, notebook PCs, game consoles, and set-top boxes typically produce internal digital RGB signals that are converted to analog RGB signals or composite video signals needed to drive external monitors or TVs. For overall compatibility with existing equipment, and the benefit of viewing the output of these devices on a larger and higher resolution display with more accurate colors, as well as a variety of other reasons, it would be desirable to be able to display the output of these devices on a HDTV display. However, the images produced by these devices cannot be displayed on a HDTV display because the signals that are produced by these devices are not quite compatible with the signals required to drive the HDTV display. Since PCs, game consoles, and set-top boxes are appearing in an increasing percentage of consumer households, there exists a growing market for a device that would enable the images produced on or by these existing devices to be experienced on a HDTV monitor. Such a device would have to, among other things, take the data and synchronizing signals produced by a PC, game console, or set-top box and convert the data and synchronizing signals into the format required by the HDTV monitor.

One internal circuit that a PC, game console, and set-top box have in common is a graphics controller, which controls the transfer of data from the PC, game console, or set-top box to the display. FIG. 1 shows graphics controller 110 providing input data 115, clock signal 114, bidirectional vertical synchronizing (“VSYNC”) signal 124, bi-directional horizontal synchronizing (“HSYNC”) signal 126, and blanking signal 128 to video encoder 130. As shown in FIG. 1, graphics controller 110 also receives clock signal 116 from video encoder 130, as well as receiving bi-directional VSYNC signal 124, bi-directional HYSNC signal 126, and bi-directional blanking signal 128 from video encoder 130. Bi-directional VSYNC signal 124 and bi-directional HYSNC signal 126 are also inputted to ASIC 112.

Video encoder 130 includes, among other things, DAC (i.e. digital to analog converter) 132, DAC 134, and DAC 136 whose respective outputs 146, 148, and 150 are coupled, respectively, to analog multiplexers (“MUXs”) 138, 140, and 142. Sync signal 120 that is generated by DAC 122 in ASIC 112 is coupled to one input of each of the three analog MUXs 138, 140, and 142. Control signal 118 that is also generated by ASIC 112 is coupled to the respective control input of analog MUXs 138, 140, and 142. Respective outputs 152, 154, and 156 of analog MUXs 138, 140, and 142 are coupled to HDTV monitor 144. As indicated by the dashed lines in FIG. 1, video encoder 130, including DACs 132, 134, and 136, ASIC 112, including DAC 122, and analog MUXs 138, 140, and 142 make up system 100.

FIG. 1 shows system 100, which takes input data 115, clock 114, VSYNC signal 124, HSYNC signal 126, and blanking signal 128 from graphics controller 110 and converts them into the required HDTV format for display on HDTV monitor 144.

In FIG. 1, graphics controller 110 is a device external to system 100 and interfaces with video encoder 130 and application-specific integrated circuit (“ASIC”) 112. Graphics controller 110 sends input data 115 to video encoder 130 where input data 115 can range from 8 bits to 24 bits. Graphics controller 110 sends input data 115 in various resolutions or modes. For example input data 115 can be sent in 640×480 mode, a standard resolution commonly known in the art as Video Graphics Array (“VGA”). Data sent in 640×480 mode refers to the fact that there are 640 pixels of data, or definable locations on a monitor screen, per “visibly active region” of each horizontal line, and there are 480 lines of pixel data displayed on the monitor screen. The term “visibly active region” refers to the part of the horizontal line that can be seen on the monitor screen.

Graphics controller 110 also sends synchronizing signals VSYNC signal 124 and HSYNC signal 126, and blanking signal 128 to video encoder 130. VSYNC signal 124, HSYNC signal 126, and blanking signal 128 are shown as bi-directional signals between graphics controller 110 and video encoder 130 because VSYNC signal 124, HSYNC signal 126, and blanking signal 128 can be sent from video encoder 130 to graphics controller 110 or vice versa. The general function of HSYNC signal 126 is to indicate the end of each horizontal line of pixel data. The general function of VSYNC signal 124 is to indicate the end of each frame of “non-interlaced” scanning of the display screen. For example, when data is sent from graphics controller 110 in 640×480 mode, VSYNC signal 124 would be sent after every 480 horizontal lines of pixel data. By way of background, “non-interlaced” scanning refers to the fact that all 480 horizontal lines of pixel data, in the example of data sent in 640×480 mode, would be sent from graphics controller 110 to video encoder 130 and ASIC 112 before VSYNC signal 124 signal would be sent. In “interlaced” scanning, the type of scanning commonly use in consumer TV sets, all the odd horizontal lines would be sent first, followed by VSYNC signal 124, and then the even horizontal lines would be sent, followed by VSYNC signal 124. In the example of video encoder 130 in FIG. 1, “non-interlaced” scanning will be used for simplicity.

As is well known in the art, a blanking signal is a signal that indicates when to turn off the scanning beam in a display screen to prevent a viewer from seeing the horizontal and vertical retrace lines on the display screen. In the example of video encoder 130 in FIG. 1, blanking signal 128 is used to prevent horizontal and vertical retrace lines from appearing on monitor 144. Clock 116 is generated in video encoder 130 and sent to graphics controller 110. Graphics controller 110 uses clock 116 to synchronize the timing of its operation, and sends clock 114, which is generally synchronized with clock 116, back to video generator 130.

As shown in FIG. 1, ASIC 112 receives VSYNC signal 124 and HSYNC signal 126 from graphics controller 110. ASIC 112 uses VSYNC signal 124 and HSYNC signal 126 to generate sync signal 120 and control signal 118. As is known in the art, HDTV requires, among other things, a tri-level synchronizing signal and a broad pulse signal to synchronize the display of data on a HDTV monitor. The function of sync signal 120 is, therefore, to provide the tri-level synchronizing signal and broad pulse signal necessary to display data on HDTV monitor 144. Analog MUX 138, analog MUX 140, and analog MUX 142 require an analog signal that is provided by sync signal 120. Control signal 118 controls MUXs 138, 140, and 142 to provide the required video and timing signals to HDTV monitor 144.

DAC 132 sends its output 146 to analog MUX 138. Suppose, for example, that input data 115 is an “RGB” digital data stream. As is well known in the art, “RGB” refers to a video standard where video data is separated into an R, or red component, a G, or green component, and a B, or blue component. Therefore, when input data 115 is an RGB digital data stream, output 146 could be either an R, a G, or a B analog component of the RGB digital data stream. Similarly, DAC 134 sends its output 148 to analog MUX 140. As in the above example, when input data 115 is an RGB digital data stream, output 148 could be an R, a G, or a B analog component of the RGB digital data stream. However, Output 146 and output 148 must be different analog components of the RGB digital data stream.

Also, DAC 136 sends its output 150 to analog MUX 142. As in the above example, when input data 115 is an RGB digital data stream, output 150 could be an R, a G, or a B analog component of the RGB digital data stream. However, output 146, output 148, and output 150 must each be different analog components R, G, and B of the RGB digital data stream. Thus, the function of DAC 132, DAC 134, and DAC 136 is to convert the respective digital component of the RGB data stream that flows into DAC 132, DAC 134, or DAC 136 into a corresponding analog component in output 146, 148, or 150 of the RGB data stream that is sent out of DAC 132, DAC 134, or DAC 136.

Analog MUX 138 receives output 146 from DAC 132, and multiplexes output 146 with the tri-level synchronizing signal and broad pulse signal from sync signal 120 at the proper time to produce output 152. Analog MUX 138 also receives control signal 118 to assist in the process of multiplexing the tri-level synchronizing and broad pulse signals from sync signal 120 at the proper time. Output 152 contains either the R, G, or B analog component of the RGB data stream from DAC 132, along with the tri-level synchronizing signal and broad pulse signal from sync signal 120 necessary to interface HDTV monitor 144.

Analog MUX 140 receives output 148 from DAC 134, and multiplexes output 148 with the tri-level synchronizing signal and broad pulse signal from sync signal 120 at the proper time to produce output 154. Analog MUX 140 also receives control signal 118 to assist in the process of multiplexing the tri-level synchronizing and broad pulse signals from sync signal 120 at the proper time. Output 154 contains either the R, G, or B analog component of the RGB data stream from DAC 134, along with the tri-level synchronizing signal and broad pulse signal from sync signal 120 necessary to interface HDTV monitor 144.

Analog MUX 142 receives output 150 from DAC 136, and multiplexes output 150 with the tri-level synchronizing signal and broad pulse signal from sync signal 120 at the proper time to produce output 156. Analog MUX 142 also receives control signal 118 to assist in the process of multiplexing the tri-level synchronizing and broad pulse signals from sync signal 120 at the proper time. Output 156 contains either the R, G, or B analog component of the RGB data stream from DAC 136, along with the tri-level synchronizing signal and broad pulse signal from sync signal 120 necessary to interface HDTV monitor 144. Thus, system 100 in FIG. 1 is an example in the art of conversion of input data 115 from graphics controller 110 into appropriate outputs 152, 154, and 156 necessary to produce a HDTV picture on HDTV monitor 144.

A problem with converting data and synchronizing signals in existing devices, such as PCs, game consoles, and set-top boxes, to a HDTV format by utilizing system 100 is that it (i.e. system 100) requires a number of circuit elements, i.e. DAC 122 in ASIC 112, and analog MUXs 138, 140, and 142, along with their necessary interconnections. The requirement of using these circuit elements adds to the size of system 100, requires additional power consumption, manufacturing time and expenses, and reduces reliability.

Another attempt in the art to convert an RGB data stream into the appropriate analog R, G, and B components of the RGB data stream to interface a HDTV monitor uses a HDTV triple-DAC module which consists of three DACs and an interface unit. Each of the three DACs in the HDTV triple-DAC module is dedicated to handle one of the R, G, or B components in the RGB data stream. By way of background, it is known in the art that the tri-level synchronization signal needed for HDTV contains a high sync level, a low sync level, and a blanking level, which is an intermediate level. For the proper functioning of the HDTV display these three levels occur with proper timing. Also, as is known in the art, HDTV also requires a broad pulse in each of the five vertical sync lines that begin each frame of video. The tri-level synchronization and the broad pulse adhere to specific timing and voltage amplitudes found in the Society of Motion Pictures and Television Engineers (“SMPTE”) specifications.

The HDTV triple-DAC module uses an HSYNC, a TSYNC, and a blanking signal to generate the required tri-level synchronization signal and the broad pulse signal. However, although the HDTV triple-DAC module provides the necessary video data and levels necessary to produce a HDTV image, the HDTV triple-DAC module does not include the necessary timing to insure that the tri-level synchronization signal, the broad pulse signal, and the video data occur with proper timing to produce an image on a HDTV display. When using the HDTV triple-DAC module, the necessary timing to insure that the tri-level synchronization signal, the broad pulse signal, and the video data occur with proper timing to produce a picture on a HDTV monitor must be generated externally. Therefore, since the HDTV triple-DAC converter requires the required timing to be generated externally, the HDTV triple-DAC converter is not a complete, selfcontained solution for converting an RGB data stream into an image on a HDTV monitor.

System 100 in FIG. 1 is an approach for converting an RGB data stream into an image on a HDTV monitor that requires a number of extra circuit elements, i.e. DAC 122 in ASIC 112, and analog MUXs 138, 140, and 142, along with their necessary external interconnections. The HDTV triple-DAC converter, on the other hand, is an approach for converting an RGB data stream into an image on a HDTV monitor that requires external timing to make it work. Thus, there is need in the art for a solution for converting an RGB data stream into an image on a HDTV monitor that is a complete solution while not requiring the additional circuit elements utilized by the existing systems. In other words, there is need in the art for a complete solution that achieves the same result as system 100, while not requiring the use of DAC 122 in ASIC 112, and analog MUXs 138, 140, and 142, along with their necessary external interconnections.

### SUMMARY OF THE INVENTION

The present invention is directed to system and method for processing HDTV format video signals. The present invention discloses a HDTV encoder that is self-contained and is a complete solution to the conversion of an input data stream into an image on a HDTV display. The present invention achieves the same result as existing HDTV video encoding systems without requiring the additional circuit elements utilized by those existing systems. As such, the invention presents a complete solution to HDTV video encoding while reducing the number of circuit elements, the manufacturing time and expenses, and overcoming reliability problems associated with the existing HDTV video encoding systems. In its various embodiments, the invention's HDTV encoder receives input data streams as well as the required HSYNC, VSYNC, and blanking signals through satellite links, wireless channels, bluetooth links, personal digital assistants, and wired remote sources and displays the received input data streams on high definition displays, such as a HDTV monitor, a display on a personal digital assistant or a display on a bluetooth appliance.

In one embodiment, the present invention comprises a HDTV timing generator having as inputs a vertical sync and a horizontal sync. The invention's HDTV timing generator outputs a digital HD level signal. The invention further comprises a DAC interface. For example, the DAC interface can include an encoder channel, or more than one encoder channel. For example, the encoder channel can include first and second input multiplexers and a DAC interface output multiplexer. By way of example, the encoder channel can receive a digital HD level signal, a SCART level signal, an NTSC level signal, a PAL level signal, and a SECAM level signal. As an example, the digital HD level signal can be an input to the first input multiplexer.

The encoder channel can further receive a HDTV format data input, a SCART format data input, an NTSC format data input, a PAL format data input, and a SECAM format data input. By way of a further example, the HDTV format data input can be an input to the second input multiplexer. The output of the DAC interface can be coupled to a DAC which in turn generates an output suitable for display on a monitor. By generating and employing the digital HD level signal in a manner disclosed in the present application, the present invention achieves the same result as the existing HDTV encoding systems while eliminating a number of previously required circuit elements and also reducing manufacturing time and expenses, and overcoming reliability problems associated with existing HDTV video encoding systems.

In various embodiments, in addition to a television set and a computer monitor, the invention's HDTV video encoder can reside, for example, in set-top boxes, personal digital assistants, bluetooth appliances, and wired or wireless telephones equipped with a high definition display. Moreover, in certain embodiments of the invention, in addition to video images and graphics information, voice and text information can also be processed and displayed on a high definition display by utilizing the invention's HDTV video encoder.

### BRIEF DESCRIPTION OF THE DRAWINGS

FIG. 1 illustrates a known technique for producing a HDTV video output on a HDTV monitor.

FIG. 2 illustrates a block diagram of an embodiment of the invention's system for processing and displaying HDTV format video signals.

FIG. 3 illustrates a detailed block diagram of an embodiment of the invention's system for processing HDTV format video signals.

FIG. 4 illustrates a detailed block diagram of an embodiment of the invention's DAC interface.

FIG. 5 illustrates various waveforms utilized by or generated in an embodiment of the present invention.

### DETAILED DESCRIPTION OF THE INVENTION

The present invention is directed to system and method for processing HDTV format video signals. The following description contains specific information pertaining to various embodiments and implementations of the invention. One skilled in the art will recognize that the present invention may be practiced in a manner different from that specifically discussed in the present application. Moreover, some of the specific details of the invention are not discussed in order not to obscure the invention. The specific details not described in the present application are within the knowledge of a person of ordinary skills in the art.

The drawings in the present application and their accompanying detailed description are directed to merely example embodiments of the invention. To maintain brevity, other embodiments of the invention that use the principles of the present invention are not specifically described in the present application and are not specifically illustrated by the present drawings.

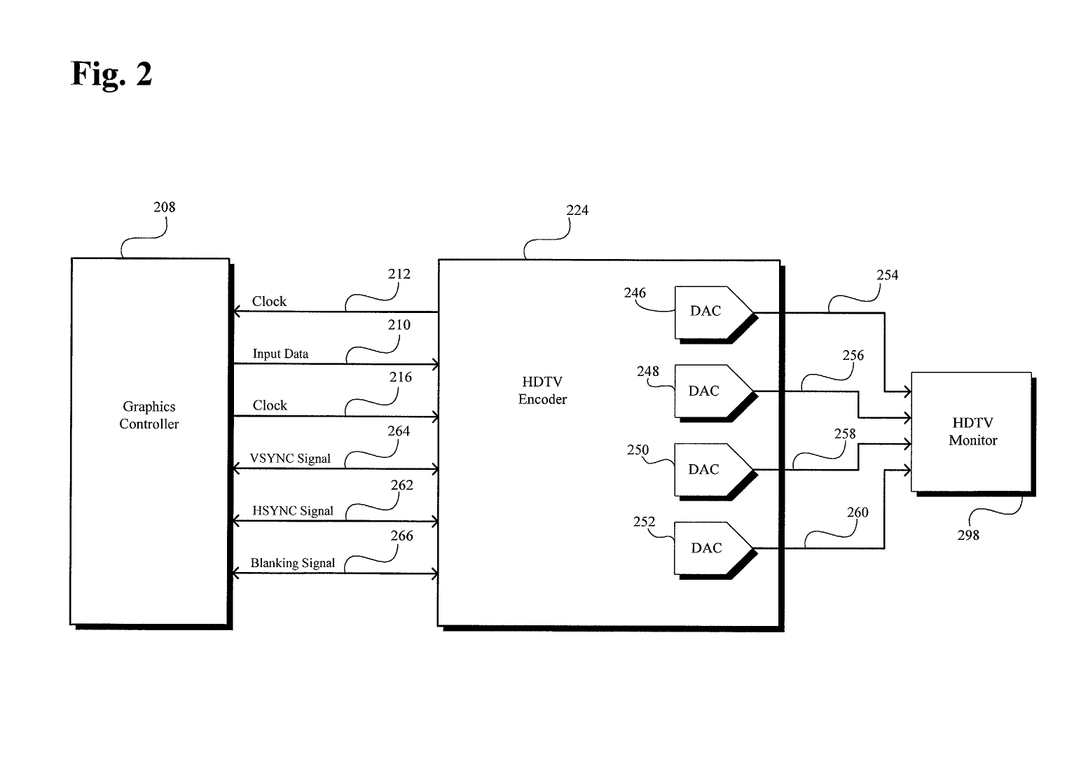

FIG. 2 shows an embodiment of the invention's HDTV encoder in block diagram form as HDTV encoder 224. FIG. 2 shows only an overview of the present embodiment's HDTV encoder 224 and does not show various other modules, some of which will be discussed below in relation to other figures in the present application. As shown in FIG. 2, HDTV encoder 224 includes DAC 246, DAC 248, DAC 250, and DAC 252 whose respective outputs 254, 256, 258, and 260 are coupled to HDTV monitor 298. As shown in FIG. 2, the present embodiment's HDTV encoder 224 receives input data 210 and clock signal 216 from graphics controller 208, as well as receiving bi-directional VSYNC signal 264, bi-directional HSYNC signal 262, and bi-directional blanking signal 266 from graphics controller 208. The exemplary embodiment of the invention's HDTV encoder 224 shown in FIG. 2, also provides clock signal 212 to graphics controller 208, as well as providing bi-directional VSYNC signal 264, bi-directional HSYNC signal 262, and bi-directional blanking signal 266 to graphics controller 208. As shown in FIG. 2, graphics controller 208 also receives clock signal 212 from the present embodiment's HDTV encoder 224, as well as receiving bi-directional VSYNC signal 264, HSYNC signal 262, and blanking signal 266 from HDTV encoder 224.

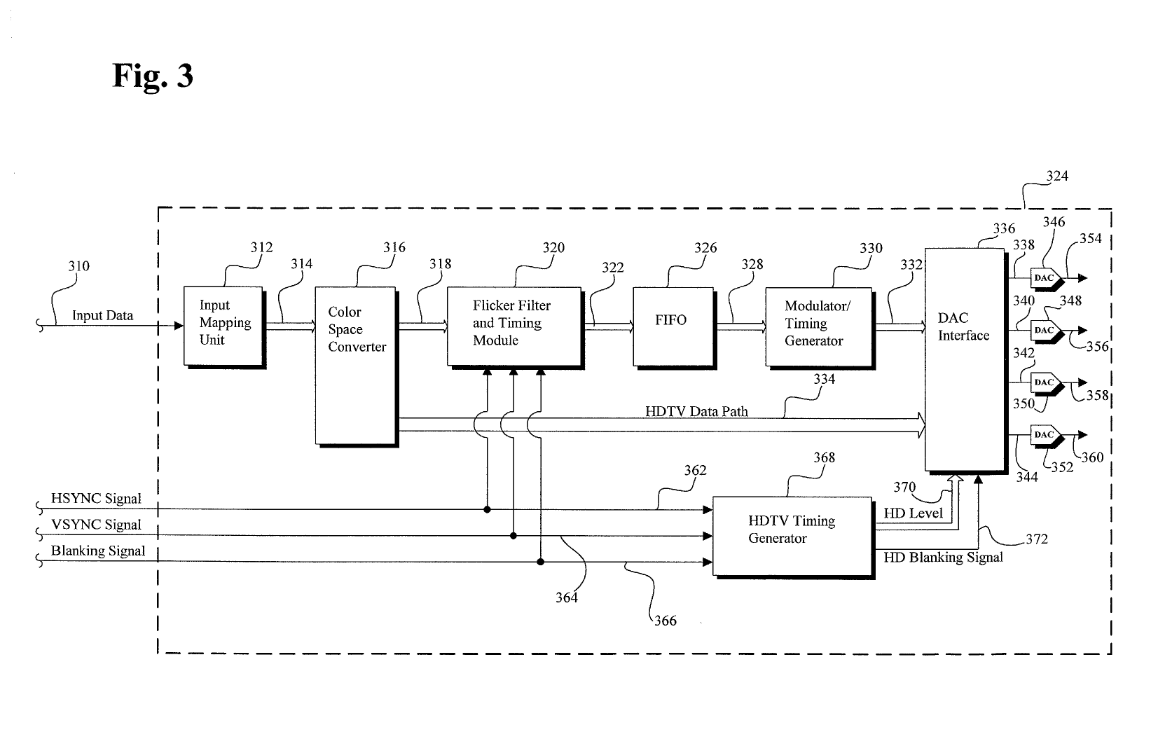

Some of the modules and components of the present embodiment of the invention not shown in FIG. 2 are shown and discussed in relation to FIG. 3. FIG. 3 shows some of the modules of HDTV encoder 224 which are referred to as HDTV encoder 324 in relation to FIG. 3. Thus, although some of the modules and components present in HDTV encoder 224 are not shown in FIG. 3, the modules that are shown in FIG. 3 are nevertheless collectively referred to as HDTV encoder 324 to preserve simplicity.

In FIG. 3, input mapping unit 312 receives input data 310 from a source external to HDTV encoder 324, for example from a graphics controller such as graphics controller 208 in FIG. 2. Input mapping unit 312 further provides its output 314 to color space converter 316. Color space converter 316 provides its output 318 to flicker filter and timing module 320 and provides HDTV data to DAC interface 336 through HDTV data path 334. Flicker filter and timing module 320 receives HSYNC signal 362, VSYNC signal 364, and blanking signal 366 from a source external to HDTV encoder 324, as well as providing its output 322 to FIFO 326. FIFO 326, in turn, provides its output 328 to modulator/timing generator 330. Modulator/timing generator 330 provides its output 332 to DAC interface 336. DAC interface 336 provides its outputs 338, 340, 342, and 344, respectively, to DACs 346, 348, 350, and 352. DAC interface 336 also receives HD level signal 370, also referred to as a “digital HD level signal” in the present application, and HD blanking signal 372 from HDTV timing generator 368. DACs 346, 348, 350, and 352, respectively, provide outputs 354, 356, 358, and 360 to, for example, a HDTV monitor. As shown in FIG. 3, HDTV timing generator 368 receives HSYNC signal 362, VSYNC signal 364, and blanking signal 366 from a source external to HDTV encoder 324, such as a graphics controller.

However, in one implementation of the present embodiment of the invention, HSYNC signal 362 and VSYNC signal 364 are not received as inputs to the invention's HDTV encoder 324. Code is embedded, in a manner known in the art, in the input data stream at input data 310. The embedded code indicates where the transitions in the HSYNC and VSYNC signals occur. From the information contained in the embedded code, input mapping unit 312 creates the HYSNC and VSYNC signals. The so created HSYNC and VSYNC signals are then provided to HDTV timing generator 368.

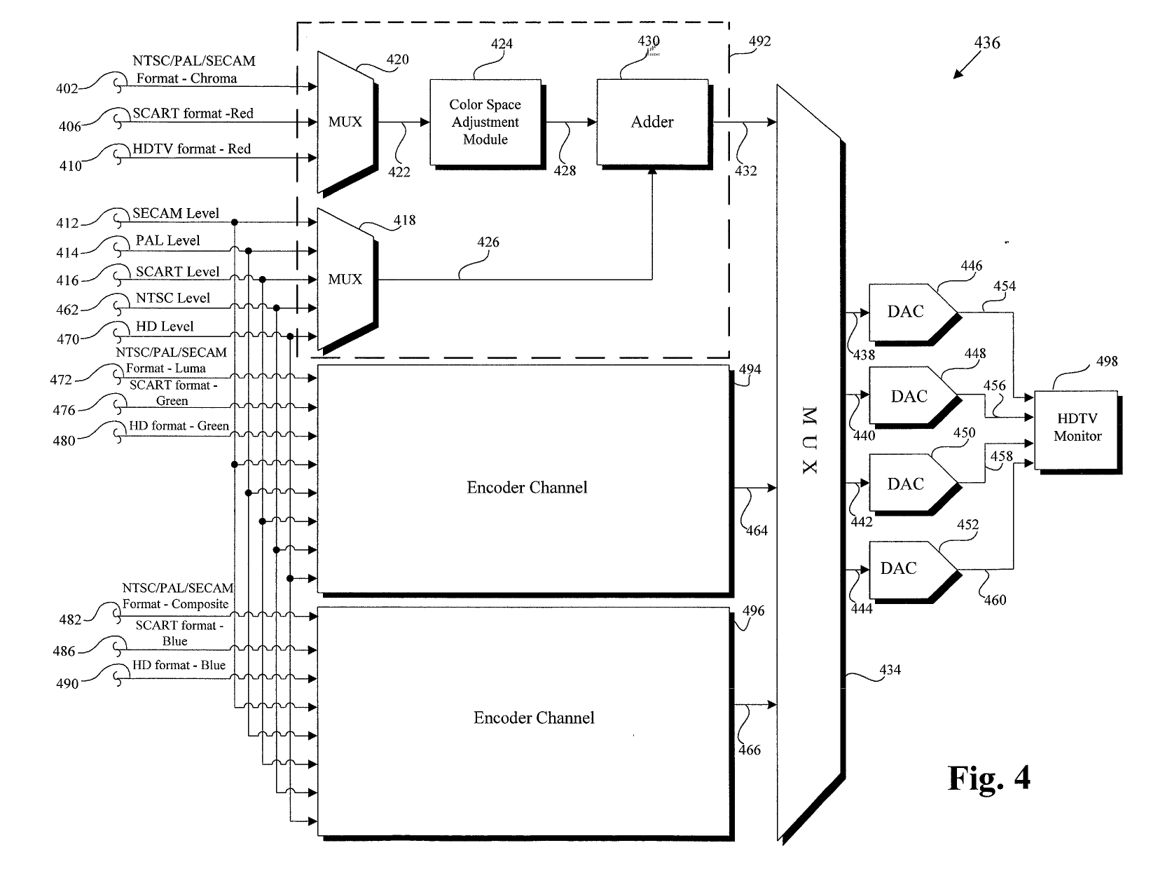

Some of the components of the present exemplary DAC interface 336 not shown in FIG. 3 are shown and discussed in relation to FIG. 4. FIG. 4 shows some of the components of DAC interface 336 which are referred to as DAC interface 436 in FIG. 4. Thus, although some of the components present in DAC interface 436 are not shown in FIG. 4, the components that are shown in FIG. 4 are nevertheless collectively referred to as DAC interface 436 to preserve simplicity. In FIG. 4, encoder channel 492 is made up of multiplexer (“MUX”) 418, also referred to as an “input multiplexer” in the present application, MUX 420, also referred to as an “input multiplexer” in the present application, color space adjustment module 424, and adder 430. In the present embodiment, encoder channels 494 and 496 comprise identical components as encoder channel 492, but the components that make up encoder channels 494 and 496 are not shown to preserve simplicity. Also, the internal interconnections of the components that make up encoder channel 492 are the same as the internal interconnections of the components that make up encoder channels 494 and 496.

In FIG. 4, MUX 420 receives NTSC/PAL/SECAM format—chroma 402, (“SCART”) format—red 406, and HDTV format—red 410, and MUX 420 provides its output 422 to color space adjustment module 424. In the present embodiment, color space adjustment module 424 performs functions related to color space conversion. Color space adjustment module 424 provides its output 428 to adder 430. Adder 430 provides its output 432 to MUX 434.

Also in FIG. 4, MUX 418 receives SECAM level 412, PAL level 414, SCART level 416, NTSC level 462, and HD level signal 470, and MUX 418 provides its output 426 to adder 430. In the present application, SECAM level 412, PAL level 414, SCART level 416, and NTSC level 462 are also referred to as various “video level” signals. Also, it is noted that HD level signal 470 in FIG. 4 corresponds to HD level signal 370 in FIG. 3. As stated above, adder 430 provides its output 432 to MUX 434. MUX 434 provides its outputs 438, 440, 442, and 444, respectively, to DACs 446, 448, 450, and 452. DACs 446, 448, 450, and 452 provide their respective outputs 454, 456, 458, and 460 to HDTV monitor 498, also referred to as HDTV monitor 298 in FIG. 2. Outputs 438, 440, 442, and 444, respectively, are also referred to as outputs 338, 340, 342, and 344 in FIG. 3. DACs 446, 448, 450, and 452, respectively, are also referred to as DACs 346, 348, 350, and 352 in FIG. 3, and also referred to as DACs 246, 248, 250, and 252 in FIG. 2. Outputs 454, 456, 458, and 460, respectively, are also referred to as outputs 354, 356, 358, and 360 in FIG. 3, and also referred to as outputs 254, 256, 258, and 260 in FIG. 2.

In FIG. 4, encoder channel 494 receives NTSC/PAL/SECAM format—luma 472, SCART format—green 476, and HDTV format—green 480 and SECAM level 412, PAL level 414, SCART level 416, NTSC level 462, and HD level signal 470. Encoder channel 494 provides its output 464 to MUX 434. Encoder channel 496 receives NTSC/PAL/SECAM format—composite 482, SCART format—blue 486, and HDTV format—blue 490, and SECAM level 412, PAL level 414, SCART level 416, NTSC level 462, and HD level signal 470. Encoder channel 496 provides its output 466 to MUX 434.

By way of overview, the present embodiment of the invention's HDTV encoder has the ability to receive non-HDTV format digital data stream, shown as input data 310 in FIG. 3, also referred to as input data 210 in FIG. 2, with a width of 15 bits per pixel, 16 bits per pixel, or 24 bits per pixel, from a graphics controller such as graphics controller 208 in FIG. 2, and it (i.e. the HDTV encoder) converts the digital data stream to a set of HDTV-compatible analog component video outputs.

Input mapping unit 312 in FIG. 3 receives input data 310 from a source external to HDTV encoder 324, for example, from a graphics controller such as graphics controller 208 in FIG. 2. An exemplary type of HDTV-compatible analog video output that can be generated by HDTV encoder 324 of the present embodiment is the “YP_{B}P_{R}” video output. The “YP_{B}P_{R}” video output comprises a “Y” component, a “P_{B}” component, a “P_{R}” component. The “YP_{B}P_{R}” video output refers to a video output that is defined in various SMPTE specifications in relation to HDTV video format. Input data 310 is typically in the form of a digital RGB data stream.

Input mapping unit 312 functions as a demultiplexer. As is known in the art, a demultiplexer can function to map or transform serial data into parallel data. Input mapping unit 312 takes input data 310, which is in the form of a digital serial data stream, and maps or transforms the serial data into parallel data. When the present embodiment's HDTV encoder 324 is in HDTV mode, input mapping unit 312 maps or transforms the input data 312, which is in a digital serial data stream form, into parallel data that, in one implementation of the present embodiment, is 15, 16, or 24 bits wide. Input mapping unit 312 provides its output 314 to color space converter 316.

Color space converter 316 converts output 314 of input mapping unit 312 from the “color space” that the data is in, for example from the “RGB” color space, to a different “color space,” such as the “YP_{B}P_{R}” color space. By way of background, a “color space” is a system utilized to specify, create, and visualize color. For example, “RGB” color space refers to a color space employed by cathode ray tube (“CRT”) displays, where excitation of red, green, and blue emitting phosphors produce various colors when fused. Color space converter 316 provides its output 318 to flicker filter and timing module 320, and color space converter 316 also drives HDTV data path 334 which in turn feeds DAC interface 336.

Flicker filter and timing module 320 incorporates normal and adaptive filtering technology for “flicker” removal and overscan compensation that allows high-quality display of non-interlaced images on an interlaced television. By way of background, televisions typically have an interlaced display, whereas personal computer (“PC”) monitors, for example, have a non-interlaced, or progressive display. Since television screens refresh, or update their images at a slower rate than PC monitors, when images created for PC monitors are shown on an interlaced television, the human eye detects the lower refresh rate, causing computer-rendered images to appear to “flicker.”

Overscan occurs when a computer image with a resolution of, for example, 800×600 is displayed on a television. Since the computer image has 600 horizontal lines of information, and a television can display only approximately 420 horizontal lines of information on the visible portion of the screen, overscan compensation is necessary so that the 600 horizontal lines of information in the computer image can be displayed in the television's 420 horizontal lines of information. Flicker filter and timing module 320 also has a timing converter to generate the timing necessary to accomplish the overscan compensation. Flicker filter and timing module 320 provides its output 322 to FIFO 326.

FIFO 326 adjusts its output 328 so that it is “synchronized” with modulator/timing generator 330. By way of background, a “FIFO” is a first-in, first-out data queue. A “FIFO” can act as a synchronizing device, for example, by clocking in data, or allowing data to enter the FIFO, at one clock frequency, and clocking the data out, or allowing the data to leave the FIFO, at a different clock frequency, thereby “synchronizing” the data to a clock frequency required by another device, such as, for example, modulator/timing generator 330. FIFO 326 provides its output 328 to modulator/timing generator 330.

Modulator/timing generator 330 is utilized to reformat the digital data stream, received from output 328 of FIFO 326, into another format. For example, RGB data in 640×480 resolution may be reformatted to SECAM composite video. Modulator/timing generator 330 also generates timing that is used in FIFO 326 to synchronize output 328 so that the digital data stream can be properly utilized by modulator/timing generator 330. The timing generator in modulator/timing generator 330, in one application, also functions to generate the signals for proper encoding of the video data into, for example, NTSC, PAL, or SECAM fornats. Modulator/timing generator 330 provides its output 332 to the invention's DAC interface 336.

DAC interface 336 digitally adds or combines the format data information with the appropriate level information for that format, and provides this information to an external device, such as a HDTV monitor. For example, HDTV format information could be digitally added to or combined with HD level information to form a single signal capable of being displayed on a HDTV monitor. DAC interface 336 is shown and discussed in detail in relation to FIG. 4. DAC interface 336 provides outputs 338, 340, 342, and 344, respectively, to DACs 346, 348, 350, and 352. DACs 346, 348, 350, and 352 convert the digital data they receive from outputs 338, 340, 342, and 344, respectively, into analog data. Generally, up to three of the four outputs 354, 356, 358, and 360 of DACs 346, 348, 350, and 352 actually provide video signals to an external monitor such as HDTV monitor 498 in FIG. 4. In other words, at any given time, at most three DACs in the group of DACs 346, 348, 350, and 352 may actually provide their respective outputs to a HDTV monitor.

HDTV timing generator 368 receives as inputs HSYNC signal 362, VSYNC signal 364, and blanking signal 366 from a graphics controller such as graphics controller 208 in FIG. 2. HDTV timing generator 368 uses HSYNC signal 362, VSYNC signal 364, and blanking signal 366 to generate HD level signal 370 and HD blanking signal 372. HD level signal 370 and HD blanking signal 372 are required when the present embodiment of the invention's HDTV encoder 324 is in the HDTV mode. HD level signal 370 provides tri-level sync and broad pulse information to DAC interface 336. HD blanking signal 372 provides blanking information to DAC interface 336. The function of HSYNC signal 362 is to alert HDTV timing generator 368 when the start of a line of pixel data occurs in relation to input data 310. The function of VSYNC signal 364 is to alert HDTV timing generator when the start of a frame of pixel data occurs in relation to input data 310. The function of blanking signal 366 is to alert the HDTV timing generator when horizontal and vertical retrace is occurring relative to input data 310. HDTV timing generator 368 provides its HD level signal 370 and its HD blanking signal 372 to DAC interface 336.

In FIG. 4, encoder channel 492, encoder channel 494, and encoder channel 496 are three encoder channels that provide their respective outputs 432, 464, and 466 to MUX 434. Encoder channel 492 is made up of MUX 418, MUX 420, color space adjustment module 424, and adder 430. MUX 420 of encoder channel 492 in FIG. 4 receives NTSC/PAL/SECAM format—chroma 402, SCART format—red 406, and HDTV format—red 410. In the present application, the NTSC format, the PAL format, and the SECAM format are also referred to as “NTSC format data input,” “PAL format data input,” and “SECAM format data input,” respectively. Moreover, the SCART format and the HDTV format are also respectively referred to as “SCART format data input” and “HDTV format data input” in the present application. NTSC/PAL/SECAM format—chroma 402, SCART format—red 406, and HDTV format—red 410 are one component of a particular format. For example, HDTV format—red 410 contains the red component of the HDTV video signal. Similarly, SCART format—red 406 contains the red component of the SCART video signal. If NTSC were selected, NTSC/PAL/SECAM format—chroma 402 would contain the chroma, or color, component of the NTSC video signal. MUX 420 provides its output 422 to color space adjustment module 424. For example, if the HDTV format is selected, MUX 420 provides the red component of the HDTV video signal as its output to color space adjustment module 424. Color space adjustment module 424 in FIG. 4 performs the last part of the color space conversion process, which is, for the most part, performed by color space converter 316 in FIG. 3. Color space conversion was discussed relative to color space converter 316 in FIG. 3. Color space adjustment module 424 provides its output 428 to adder 430.

MUX 418 receives as inputs SECAM level 412, PAL level 414, SCART level 416, NTSC level 462, and HD level signal 470. These levels are the required synchronization levels for the specific formats, such as SECAM, PAL, SCART, NTSC, and HDTV formats. For example, in the HDTV mode, the HDTV level consists of a digital representation of the tri-level sync signal and the broad pulse signal. MUX 418 provides the selected format level as its output 426. MUX 418 provides output 426 to adder 430.

Adder 430 receives output 428 from color space adjustment module 424 and output 426 from MUX 418. Adder 430 then digitally “adds” output 428 and output 426. Adder 430 provides its output 432 to MUX 434. For example, in the HDTV mode, adder 430 receives the red component of the HDTV video signal from MUX 420 and “adds” it to HD level signal 470 that consists of a digital representation of the tri-level sync signal and the broad pulse signal. The resulting digital signal, i.e. output 432, after conversion to an analog signal, will be provided to a HDTV monitor, such as HDTV monitor 498. However, since output 432 is only the red component of the HDTV video signal, the blue and green components of the HDTV video signal are necessary to provide a complete image on the HDTV monitor.

Encoder channel 494 receives inputs NTSC/PAL/SECAM format—luma 472, SCART format—green 476, and HDTV format—green 480. NTSC/PAL/SECAM format—luma 472, SCART format—green 476, and HDTV format—green 480 are one component of a particular format. For example, HDTV format—green 480 contains the green component of the HDTV video signal. Similarly, SCART format—green 476 contains the green component of the SCART video signal. If NTSC were selected, for example, NTSC/PAL/SECAM format—luma 472 would contain the luma, or lightness, component of the NTSC video signal. Encoder channel 494 also receives as inputs SECAM level 412, PAL level 414, SCART level 416, NTSC level 462, and HD level signal 470. These levels are the required synchronization levels for the specific formats, such as SECAM, PAL, SCART, NTSC, and HDTV. For example, for HDTV the HDTV level consists of a digital representation of the tri-level sync signal and the broad pulse signal. Encoder channel 494 provides its output 464 to MUX 434, also referred to as a “DAC interface output multiplexer” in the present application.

Encoder channel 496 receives inputs NTSC/PAL/SECAM format—composite 482, SCART format—blue 486, and HDTV format—blue 490. NTSC/PAL/SECAM format—composite 482, SCART format—blue 486, and HDTV format—blue 490 are one component of a particular format. For example, HDTV format—blue 490 contains the blue component of the HDTV video signal. Similarly, SCART format—blue 486 contains the blue component of the SCART video signal. If NTSC were selected, for example, NTSCIPAL/SECAM format—composite 482 would contain the composite video of the NTSC video signal. Encoder channel 496 also receives as inputs SECAM level 412, PAL level 414, SCART level 416, NTSC level 462, and HD level signal 470. These levels are the required synchronization levels for the specific formats, such as SECAM, PAL, SCART, NTSC, and HDTV. For example, for HDTV the HDTV level consists of a digital representation of the tri-level sync signal and the broad pulse signal. Encoder channel 496 provides its output 466 to MUX 434.

MUX 434 outputs 438, 440, 442, and 444, respectively, to DACs 446, 448, 450, and 452. Any one of encoder channel outputs 432, 464, or 466 that are received by MUX 434 can be provided to any one of DACs 446, 448, 450, or 452. Each of MUX 434 outputs 438, 440, 442, or 444 can contain a specific component of video format selected. For example if the HDTV format is selected, output 438 could contain the red component of the HDTV video signal, output 440 could contain the green component of the HDTV video signal, and output 442 could contain the blue component of the HDTV video signal.

DACs 446, 448, 450, and 452 provide their respective outputs 454, 456, 458, and 460 to HDTV monitor 498. Each DAC 446, 448, 450, or 452 converts digital signals at its input to analog signals at its output. For example, DAC 446 converts output 438, a digital signal, to output 454, an analog signal. When the exemplary embodiment of the present invention's HDTV converter 324 is in the HDTV mode, outputs 454, 456, 458, and 460 can be provided to a monitor, such as HDTV monitor 498. Depending on which outputs are selected by MUX 434, any three of outputs 454, 456, 458, or 460 can each contain one of the red, green, or blue components of the HDTV signal. For example, output 454 could contain the red component of the HDTV signal, output 456 could contain the green component of the HDTV signal, and 458 could contain the blue component of the HDTV signal.

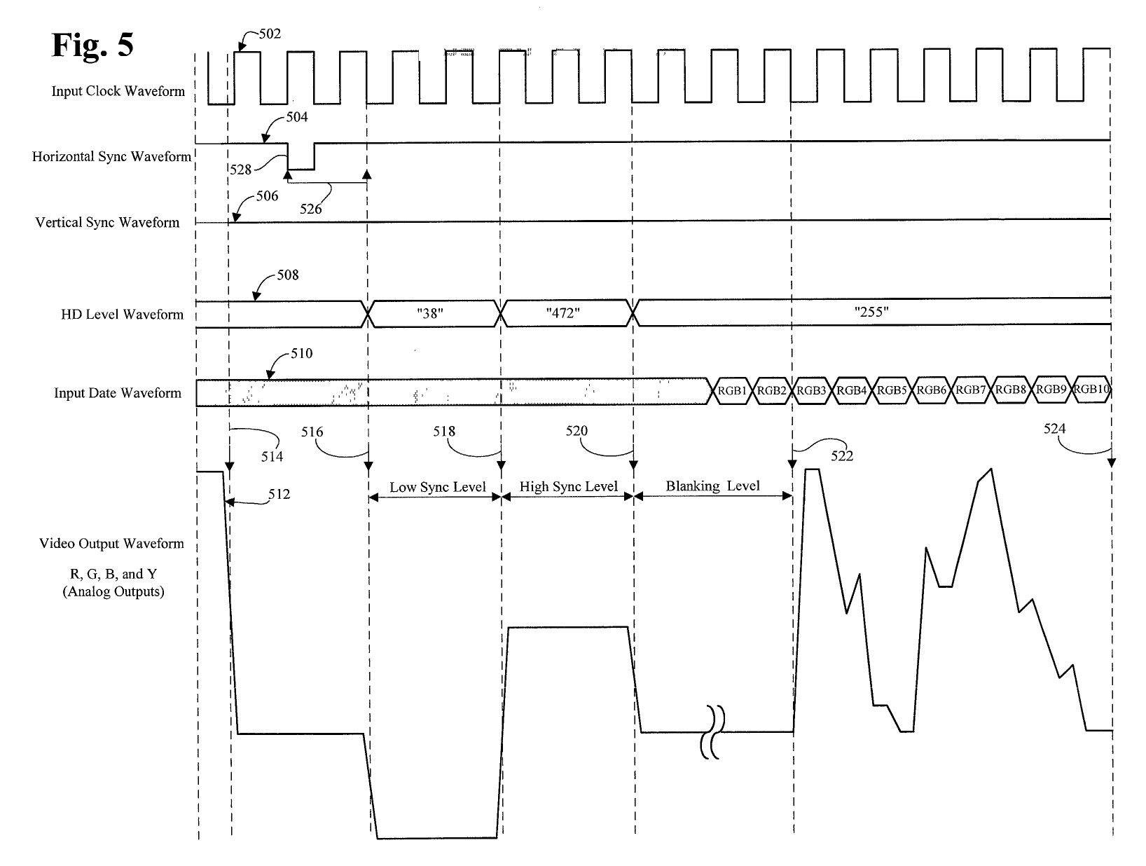

Timing diagram 500 in FIG. 5 illustrates the timing relationships between the various signals that are required to produce a HDTV image when the present embodiment of the invention's HDTV encoder 324 is in the HDTV mode. In FIG. 5, time is indicated along the horizontal axis and amplitude is indicated along the vertical axis.

Clock waveform 502 corresponds to a clock signal used in the present embodiment of the invention, such as clock 216 in FIG. 2. In one implementation, clock waveform 502 is provided to the invention's HDTV encoder 324 by an external device, such as graphics controller 208 in FIG. 2. Horizontal sync waveform 504 corresponds to HSYNC signal 262 in FIG. 2, which is provided to the invention's HDTV encoder 324 by an external device, such as graphics controller 208 in FIG. 2. Vertical sync waveform 506 corresponds to VSYNC signal 264 in FIG. 2, which is provided to the invention's HDTV encoder 324 by an external device, such as graphics controller 208 in FIG. 2. HD level waveform 508 corresponds to HD level signal 370 in FIG. 3 (or HD level signal 470 in FIG. 4), which is generated by the invention's HDTV encoder. Input data waveform 510 corresponds to input data 210 in FIG. 2, which is provided to the invention's HDTV encoder 324 by an external device, such as graphics controller 208 in FIG. 2. Video output waveform 512 represents an exemplary horizontal line of data and synchronizing signals that can be generated by the present invention's HDTV encoder 324 at any of DAC outputs 354, 356, 358, or 360 in FIG. 3. In the present application, video output waveform 512 is also referred to as an “HDTV video output waveform” when the invention's HDTV encoder 324 is in the HDTV mode.

Time 514 represents the starting time of the blanking period, which is generated by an external device, such as graphics controller 208 in FIG. 2, and is communicated to the invention's HDTV encoder 324 through blanking signal 366, also referred to as blanking signal 266 in FIG. 2. By way of background, a “tri-level sync” is required for HDTV. Various details regarding the timing of the “tri-level sync” are found in the SMPTE specifications. The “tri-level sync” spans the combined time periods occurring between time 516 and time 522 in video output waveform 512. Time 516 represents the start of the low sync level of the “tri-level sync” generated by the present invention's HDTV encoder 324. Briefly, the “tri-level sync” has three sync levels, a low sync level, a high sync level, and a blanking, or intermediate level. Time 518 represents the start of the high sync level, a part of the tri-level sync generated by the present invention's HDTV encoder 324. Time 520 represents the start of the blanking level, a part of the tri level sync generated by the present invention's HDTV encoder 324. The blanking level is also referred to as a “blanking sync level” in the present application. Time 522 represents the end of the blanking level of the tri-level sync and the start of the active data region that is generated by the present invention's HDTV encoder 324. Time 524 represents the end of the active data region.

Clock waveform 502 is the timing reference used by the invention's HDTV encoder 324. The invention's HD level waveform 508, which is output on HD level signal 370 (FIG. 3), triggers and shapes the tri-level sync that appears at appropriate time periods on respective DAC outputs 454, 456, 458, and 460. The timing of the invention's HD level waveform 508 is related to the timing of horizontal sync waveform 504. The present embodiment of the invention generates an appropriate HD level waveform 508 after passage of certain number of clock cycles. In one implementation, the invention begins outputting HD level waveform 508 after passage of approximately 11 clock cycles after falling edge, i.e. a high to low transition, 528 of horizontal sync waveform 504. This exemplary delay of 11 clock cycles is indicated by numeral 526 in FIG. 5.

According to the present embodiment of the invention, HD level signal 370 (FIG. 3) triggers the start of the low sync level period at a corresponding DAC output, i.e. at one of DAC outputs 454, 456, 458, and 460. Thus, according to one embodiment of the invention, HD level waveform 508 which appears at HD level signal 370 triggers the start of a low sync level at time 516 in video output waveform 512. In one implementation of the present embodiment, HD level signal 370 comprises nine bits of information. According to this implementation, in order to generate the start of the low sync level, HD level waveform 508 represents a digital value of “38” which is transmitted through HD level signal 370 to DAC interface 336. HD level waveform 508 remains at the “38” digital value long enough to cause video output waveform 512 to remain in low sync level. In other words, HD level waveform 508 remains at a digital value corresponding to a “38” long enough such that the low sync level extends to time 518 in video output waveform 512.

At time 518, HD level waveform 508 which appears at HD level signal 370 triggers the start of a high sync level in video output waveform 512. According to this implementation of the present embodiment, in order to generate the start of the high sync level, HD level waveform 508 represents a digital value of “472” which is transmitted through HD level signal 370 to DAC interface 336. HD level waveform 508 remains at “472” digital value long enough to cause video output waveform 512 to remain in high sync level. In other words, HD level waveform 508 remains at a digital value corresponding to a “472” long enough such that the high sync level extends to time 520 in video output waveform 512.

At time 520, HD level waveform 508 which appears at HD level signal 370 triggers the start of a blanking or intermediate level in video output waveform 512. According to this implementation of the present embodiment, in order to generate the 102l start of the blanking or intermediate level, HD level waveform 508 represents a digital value of “255” which is transmitted through HD level signal 370 to DAC interface 336. HD level waveform 508 remains at the “255” digital value long enough to cause video output waveform 512 to remain in blanking or intermediate level. In other words, HD level waveform 508 remains at a digital value corresponding to a “255” long enough such that the blanking or intermediate level extends to time 522 in video output waveform 512.

At time 522, according to the present embodiment of the invention, active data appears at a corresponding DAC output, i.e. at one of DAC outputs 454, 456, 458, or 460. The period that extends from time 516, i.e. from the time at which video output waveform 512 enters the low sync level, to time 522, i.e. when the blanking level ends and active data begins to be output by video output waveform 512, is a predetermined number of clock cycles, depending on which Advanced Television Systems Committee (“ATSC”) video format is appearing at the corresponding DAC output. By way of background, the Advanced Television Systems Committee (“ATSC”), formed to establish voluntary technical standards for advanced television systems such as HDTV has advanced various ATSC video formats, or HD resolutions for HDTV. Some of the ATSC video formats supported by the present embodiment of HDTV encoder 324 are 1080i, defined in SMPTE 274M, 720p, defined in SMPTE 296M, and 480p, defined in SMPTE 293M. The ATSC 1080i and 720p video formats require tri-level sync pulses. In the 1080i video format, as implemented by the present embodiment of the invention's HDTV encoder 324, the low sync level and the high sync level each last for 44 clock pulses of clock waveform 502. In the 720p video format, as implemented by the present embodiment of the invention's HDTV encoder 324, the low sync level and the high sync level each last for 40 clock pulses of clock waveform 502.

In the ATSC 1080i video format, HD level waveform 508 will remain at the “38” digital value, corresponding to the low sync level, for 44 clock cycles, and will remain at the “472” digital value, corresponding to the high sync level, for 44 clock cycles. In the ATSC 720p video format, HD level waveform 508 will remain at the “38” digital value, corresponding to the low sync level, for 40 clock cycles, and will remain at the “472” digital value, corresponding to the high sync level, for 40 clock cycles.

Therefore, in the ATSC 1080i video format, the period that spans from time 516, i.e. from the time at which video output waveform 512 enters the low sync level, to time 522, i.e. when the blanking level ends and active data begins to be output by video output waveform 512, is 176 clock cycles in duration. In other words, in the ATSC 1080i video format there is a 176 clock cycle delay between time 516, when HD level waveform 508 represents a “38” digital value, i.e. when HD level waveform 508 triggers the tri-level sync that appears on respective DAC outputs 454, 456, 458, and 460, and the start of active data at the respective DAC output. In the ATSC 720p video format, the period that extends from time 516, when HD level waveform 508 represents a “38” digital value, to time 522, when the blanking period ends and active data begins appearing at a corresponding DAC output is 172 clock cycles in duration. In other words, in the ATSC 720p video format there is a 172 clock cycle delay between time 516, when HD level waveform 508 represents a “38” digital value, i.e. when HD level waveform 508 triggers the tri-level sync that appears on respective DAC outputs 454, 456, 458, and 460, and the start of active data at the respective DAC output.

Vertical sync waveform 506 occurs at the end of a “frame” in the ATSC 720p video format, and at the end of each “field” in the ATSC 1080i video field. By way of background, ATSC 720p is a non-interlaced video standard, where all of the horizontal lines of pixel data are sent to a monitor in a “frame,” followed by a vertical sync pulse at the end of the “frame.” By comparison, ATSC 1080i is an interlaced video standard, where two “fields” make up a “frame,” with a vertical sync pulse occurring at the end of each “field.” When the embodiment of the invention's HDTV encoder 324 is in the HDTV mode, a broad pulse must be inserted at DAC outputs 454, 456, 458, and 460 in the first five lines of each “frame” for ATSC 720p video format, or the first five lines of each “field” for ATSC 1080i video format, as detailed in various SMPTE specifications.

According to one embodiment of the invention, after VSYNC signal 264 (in FIG. 2), corresponding to sync waveform 506, occurs, signaling the start of either a new field, for ATSC 1080i video format, or a new frame, for ATSC 720p video format, HD level signal 370 triggers the start of a broad pulse level, and HD level waveform 508 represents a digital value of “38,” which is transmitted through HD level signal 370 to DAC interface 336. In the present example, the digital value of “38” represented by HD level waveform 508 is generated after passage of 172 clock pulses from the start of the low sync level at time 516 in the ATSC 720p format. Similarly, the digital value of “38” represented by HD level waveform 508 is generated after passage of 176 clock pulses from the start of the low sync level at time 516 in the ATSC 1080i video format. HD waveform 508 remains at a digital value “38” long enough to cause video output waveform 512 to remain at the broad pulse level. Thereafter, HD level signal 370 triggers the end of the broad pulse level by returning to the blanking level. The sequence of generating and inserting a broad pulse level at a corresponding DAC output, i.e. at a respective DAC output 454, 456, 458, or 460 is repeated for the first five lines of pixels. For example, in ATSC 720p video format the invention's HDTV encoder 324 inserts a broad pulse in the first five lines of pixels, i.e. lines 1 through 5.

As shown by video output waveform 512, in the present embodiment of the invention, HD level signal 370 maintains an output digital value of “255,” also referred to as an “active level” in the present application, from time 522, i.e. from the end of blanking sync level, to time 524, i.e. to the end of active data period. As such, HD level signal 370 ensures that the active data portion of input data waveform 510, which starts at time 522 of video output waveform 512, is outputted with appropriate timing and offset level by a respective DAC output 454, 456, 458, or 460. More specifically, video output waveform 512 is representative of either the red, green, or blue component of the HDTV video signal at DAC outputs 454, 456, 458, and 460. The red, green, or blue component of the HDTV video signal is offset by approximately +350 millivolts to accommodate the negative sync levels listed in the various SMPTE specifications for HDTV. The +350 millivolt offset is necessary because the present embodiment of the invention's HDTV encoder 324 does not transmit negative voltages.

It is manifest to a person of ordinary skill in the art that various embodiments of the invention's HDTV encoder 324 can reside in various devices. In one embodiment, the invention's HDTV encoder 324 resides in a television set or a computer monitor. In that embodiment, inputs such as HSYNC signal 362, VSYNC signal 364, blanking signal 366, and input data 310 can be, by way of non-exhaustive examples, supplied to HDTV encoder 324 directly from a remote source such as a satellite, a server on the Internet, or from a graphics controller residing inside the television set or the computer monitor.

In addition to utilizing the invention's HDTV encoder 324 in a television set or a computer monitor, HDTV encoder 324 can also be used in a “set-top box.” “Set-top box” is a term commonly used to refer to a cable TV box that “sits on top” of the TV set. A set-top box can generally receive video signals, as well as data and voice signals, from conventional television stations as well as from the Internet, all through co-axial cable TV lines, or optical fibers. When used in a set-top box, inputs such as HSYNC signal 362, VSYNC signal 364, blanking signal 366, and input data 310 can be, by way of non-exhaustive examples, supplied to HDTV encoder 324 directly from a remote source such as a satellite, a server on the Internet, or from a graphics controller residing inside the set-top box.

The present invention's HDTV encoder may also reside in a personal digital assistant equipped with a high definition display. In that case, inputs such as HSYNC signal 362, VSYNC signal 364, blanking signal 366, and input data 310 can be, by way of non-exhaustive examples, supplied to HDTV encoder 324 directly from a processor in the personal digital assistant, from a storage medium inside the personal digital assistant, from an external personal computer in communication with the assistant through a parallel or serial port, or through a local infra-red or a bluetooth link.

By way of another example, the present invention's HDTV encoder may reside in a wired or wireless telephone equipped with a high definition display. In that case, inputs such as HSYNC signal 362, VSYNC signal 364, blanking signal 366, and input data 310 can be, by way of non-exhaustive examples, supplied to HDTV encoder 324 directly from a processor in the telephone, from a base station through wireless CDMA, TDMA, or FDMA channels, through the public switched telephone network by means of optical fibers or twisted pair wires, or through a local infra-red or a bluetooth link.

By way of yet another example, the present invention's HDTV encoder may reside in a bluetooth appliance equipped with a high definition display. In that case, inputs such as HSYNC signal 362, VSYNC signal 364, blanking signal 366, and input data 310 can be, by way of non-exhaustive examples, supplied to HDTV encoder 324 directly from a processor in the appliance, or from another bluetooth appliance or a personal computer. In the present application, various sources such as graphics controllers, Internet servers, storage media, satellites, or other sources such as those specifically mentioned in the present application by way of non-exhaustive examples, are generally referred to as “information sources.”

In various embodiments of the invention, i.e. whether the invention's HDTV video encoder resides in a television set, a computer monitor, a set-top box, a personal digital assistant, a telephone, or a bluetooth appliance, HDTV encoder 324 can be utilized to process and display voice and text information as well as video images and graphics information on a high definition display. For example, teletext containing “TV guide” information can be transmitted to a set-top box equipped with the invention's HDTV encoder 324. The set-top box then processes the teletext through the invention's HDTV encoder 324 and displays the teletext on a high definition display. As another example, after processing voice through voice recognition software, text representing the voice may be displayed on a high definition display utilizing the invention's HDTV encoder 324.

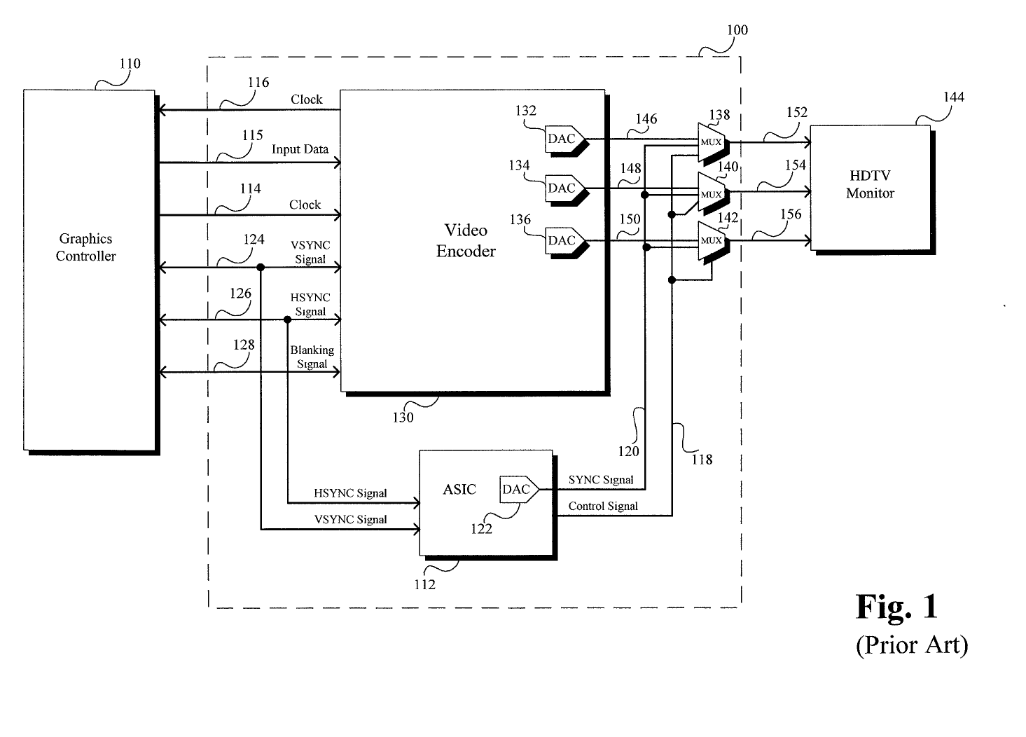

As shown by the generation of HD level signal 370, the present embodiment of the invention's HDTV encoder 324 overcomes the disadvantages of the related art described in the background art section by being a self-contained, complete solution for the conversion of an input data stream, such as an input RGB data stream, into an image on a HDTV monitor. Through HD level signal 370, the present invention eliminates components such as ASIC 112, including DAC 122, and MUXs 138, 140, and 142 in system 100 in FIG. 1. In other words, the present invention achieves the same result as the existing HDTV video encoding systems without requiring the additional circuit elements utilized by those existing systems. As such, the invention presents a solution to the conversion of an input data stream into an image on a HDTV monitor that utilizes only a single, integrated component, i.e. HDTV encoder 324. By reaching this solution, the invention reduces the number of circuit elements, the manufacturing time and expenses, and overcoming reliability problems associated with the existing HDTV video encoding systems. Moreover, by providing the necessary timing signals, HD level signal 370 overcomes the disadvantages of the presently known HDTV triple-DAC converter's requirement of external timing for the conversion of an input data stream into an image on a HDTV monitor.

While certain embodiments of the invention are specifically illustrated in the drawings and are specifically described herein, it is apparent to those of ordinary skill in the art that the specific embodiment described herein may be modified without departing from the inventive concepts described. In its various embodiments, the invention's HDTV encoder receives input data streams as well as the required HSYNC, VSYNC, and blanking signals through satellite links, wireless channels, bluetooth links, personal digital assistants, and wired remote sources and displays the received input data streams on high definition displays, such as a HDTV monitor, a display on a personal digital assistant or a display on a bluetooth appliance. It is apparent to one of ordinary skill in the art to utilize the invention's teachings, such as generation of a digital HD level signal as disclosed herein, and achieve the same reduction in the number of required circuit elements in the various embodiments of the invention mentioned above. In other words, the advantages of the present invention extend to its various embodiments which include use of the invention's HDTV encoder in connection with satellite links, wireless channels, bluetooth links, personal digital assistants, and wired remote sources to display the received input data streams on high definition displays.

In one embodiment of the invention, input data 310 is a digital “YPbPr” data stream instead of an RGB data stream. As is known in the art, “YPbPr” refers to a color-difference digital signal that a standard digital YCrCb data stream, used in consumer systems such as set-top boxes, can be converted to (as such, the digital “YPbPr” data stream should not be confused with “YP_{B}P_{R}” video output). In one embodiment of the invention, after a standard digital YCrCb data stream is converted into a digital YPbPr data stream, the resulting digital YPbPr data stream will be in a form that can be converted by the invention's HDTV encoder into YPBPR video output that is ready to be viewed on a HDTV monitor.

Moreover, while the embodiment of the invention described above specifically illustrated the invention's concepts in relation to operation in the HDTV video format, the invention's concepts also apply to other types of video formats. Specifically, FIG. 4 of the exemplary embodiment of the invention illustrated DAC interface 436 that accepts NTSC/PAL/SECAM or SCART video format data and the corresponding video format levels. It is apparent to one of ordinary skill in the art that a signal analogous to HD level signal 370 can be devised and inputted to DAC interface 436 and by means of which appropriate video output waveforms, such as video output waveform 512, can be generated for any of the NTSC/PAL/SECAM or SCART video formats while preserving the advantages of the exemplary embodiment of the invention, such as a reduced component count, described above.

Thus, system and method for processing HDTV format video signals have been described.

1. A system comprising:
a HDTV timing generator having an HSYNC input and a VSYNC input, said HDTV timing generator outputting a digital HD level signal;
a DAC interface having an input coupled to said digital HD level signal;
an output of said DAC interface being coupled to a DAC.

2. The system of claim 1 wherein an output of said DAC is coupled to a display, whereby said output of said DAC produces an image on said display.

3. The system of claim 1 wherein said DAC interface comprises a plurality of encoder channels, at least one of said plurality of encoder channels receiving said digital HD level signal as an input.

4. The system of claim 3 wherein at least one of said plurality of encoder channels receives a HDTV format data input.

5. The system of claim 4 wherein at least one output of at least one of said plurality of encoder channels is coupled to said DAC through a multiplexer.

6. The system of claim 4 wherein at least one of said plurality of encoder channels receives an input selected from the group consisting of a SCART format data input, an NTSC format data input, a PAL format data input, and a SECAM format data input.

7. The system of claim 4 wherein said HDTV format data input is coupled to an input of a multiplexer in said at least one of said plurality of encoder channels.

8. The system of claim 4 wherein said digital HD level signal is coupled to an input of a multiplexer in said at least one of said plurality of encoder channels.

9. The system of claim 7 wherein said digital HD level signal is coupled to said input of said multiplexer.

10. The system of claim 7 wherein an NTSC format data input, a PAL format data input, a SECAM format data input, and a SCART format data input are coupled to said input of said multiplexer.

11. The system of claim 8 wherein a SECAM level signal, a PAL level signal, a SCART level signal, and an NTSC level signal are coupled to said input of said multiplexer.

12. The system of claim 1 further comprising a modulator/timing generator having an output coupled to said DAC interface.

13. The system of claim 12 further comprising a FIFO having an output coupled to said modulator/timing generator.

14. The system of claim 1 further comprising a color space converter having an output coupled to said DAC interface.

15. The system of claim 14 wherein said output of said color space converter is coupled to a HDTV data path, and wherein said HDTV data path is coupled to said DAC interface.

16. The system of claim 1 wherein said system is connected to a television set, said system transforming information received by said television set for display on a high definition display.

17. The system of claim 16 wherein said information is selected from the group consisting of video image information, graphics information, text information, and voice information.

18. The system of claim 17 wherein said information is received by said television set from an information source selected from the group consisting of a satellite, an Internet server, and a graphics controller.

19. The system of claim 1 wherein said system is connected to a computer, said system transforming information received by said computer for display on a high definition display.

20. The system of claim 19 wherein said information is selected from the group consisting of video image information, graphics information, text information, and voice information.

21. The system of claim 20 wherein said information is received by said computer from an information source selected from the group consisting of a satellite, an Internet server, and a graphics controller.

22. The system of claim 1 wherein said system is connected to a set-top box, said system transforming information received by said set-top box for display on a high definition display.

23. The system of claim 22 wherein said information is selected from the group consisting of video image information, graphics information, text information, and voice information.

24. The system of claim 23 wherein said information is received by said set-top box from an information source selected from the group consisting of a satellite, an Internet server, and a graphics controller.

25. The system of claim 1 wherein said system is connected to a personal digital assistant, said system transforming information received by said personal digital assistant for display on a high definition display.

26. The system of claim 25 wherein said information is selected from the group consisting of video image information, graphics information, text information, and voice information.

27. The system of claim 26 wherein said information is received by said personal digital assistant from an information source selected from the group consisting of a processor, a storage medium, and a personal computer.

28. The system of claim 1 wherein said system is connected to a telephone, said system transforming information received by said telephone for display on a high definition display.

29. The system of claim 28 wherein said information is selected from the group consisting of video image information, graphics information, text information, and voice information.

30. The system of claim 29 wherein said information is received by said telephone from an information source selected from the group consisting of a processor, a base station, and a public switched telephone network.

31. The system of claim 1 wherein said system resides in a bluetooth appliance, said system transforming information received by said bluetooth appliance for display on a high definition display.

32. The system of claim 31 wherein said information is selected from the group consisting of video image information, graphics information, text information, and voice information.

33. The system of claim 32 wherein said information is received by said bluetooth appliance from an information source selected from the group consisting of a processor and a personal computer.

34. A method to generate a HDTV video output waveform, said method comprising steps of:
receiving a horizontal sync waveform;
receiving a vertical sync waveform;
receiving an input data waveform;
generating a digital HD level signal, said digital HD level signal causing said HDTV video output waveform to be generated corresponding to said input data waveform.

35. The method of claim 34 wherein said digital HD level signal causes said HDTV video output waveform to be at a level selected from the group consisting of a low sync level, a high sync level, a blanking level, and an active level.

36. The method of claim 35 wherein said input data waveform is displayed on a display during a period when said digital HD level signal causes said HDTV video output waveform to be at said active level.

37. The method of claim 34 wherein said digital HD level signal causes said HDTV video output waveform to be at a low sync level after a plurality of clock cycles has passed since a high to low transition of said horizontal sync waveform.

38. The method of claim 34 wherein said digital HD level signal causes said HDTV video output waveform to be at a high sync level after a plurality of clock cycles has passed since a high to low transition of said horizontal sync waveform.

39. The method of claim 34 wherein said digital HD level signal causes said HDTV video output waveform to be at a blanking sync level after a plurality of clock cycles has passed since a high to low transition of said horizontal sync waveform.

40. The method of claim 34 wherein said digital HD level signal causes said HDTV video output waveform to be at an active level after a plurality of clock cycles has passed since a high to low transition of said horizontal sync waveform.

41. The method of claim 34 further comprising a step of supplying said digital HD level signal to a DAC interface.

42. The method of claim 41 wherein an output of said DAC interface is coupled to a display.

43. The method of claim 41 wherein said input data waveform is a HDTV format data input, and wherein said HDTV format data input is supplied to said DAC interface.

44. The method of claim 41 wherein said input data waveform is selected from the group consisting of a HDTV format data input, an NTSC format data input, a PAL format data input, a SECAM format data input, and a SCART format data input, and wherein said input data waveform is supplied to said DAC interface.

45. The method of claim 44 further comprising a step of supplying a signal selected from the group consisting of an NTSC level signal, a PAL level signal, a SECAM level signal, and a SCART level signal to said DAC interface.

46. A system comprising:
a HDTV timing generator having an HSYNC input and a VSYNC input, said HDTV timing generator outputting a digital HD level signal;
a DAC interface having an input coupled to said digital HD level signal;
said DAC interface comprising a plurality of encoder channels, at least one of said plurality of encoder channels receiving said digital HD level signal and a video level signal selected from the group consisting of a SECAM level signal, a PAL level signal, a SCART level signal, and an NTSC level signal;
an output of said DAC interface being coupled to a DAC, an output of said DAC being suitable for producing an image on a display.

47. The system of claim 46 wherein at least one of said plurality of encoder channels receives a HDTV format data input.

48. The system of claim 46 wherein an output of at least one of said plurality of encoder channels is coupled to said DAC through a multiplexer.

49. The system of claim 46 wherein at least one of said plurality of encoder channels receives an input selected from the group consisting of a SCART format data input, an NTSC format data input, a PAL format data input, and a SECAM format data input.

50. The system of claim 47 wherein said HDTV format data input is coupled to an input of a multiplexer in said at least one of said plurality of encoder channels.

51. The system of claim 47 wherein said digital HD level signal is coupled to an input of a multiplexer in said at least one of said plurality of encoder channels.

52. The system of claim 50 wherein said digital HD level signal is coupled to said input of said multiplexer.

53. The system of claim 50 wherein an NTSC format data input, a PAL format data input, a SECAM format data input, and a SCART format data input are coupled to said input of said multiplexer.

54. The system of claim 51 wherein said SECAM level signal, said PAL level signal, said SCART level signal, and said NTSC level signal are coupled to said input of said multiplexer.

55. The system of claim 46 further comprising a color space converter having an output coupled to said DAC interface.

56. The system of claim 55 wherein said output of said color space converter is coupled to a HDTV data path, and wherein said HDTV data path is coupled to said DAC interface.

57. A HDTV encoder comprising:
means for receiving an HSYNC input and a VSYNC input;
means for generating a digital HD level signal;
means for interfacing with a DAC, said means for interfacing with said DAC having an input coupled to said means for generating said digital HD level signal;
an output of said means for interfacing with said DAC being coupled to a DAC, and an output of said DAC being coupled to a means for displaying HDTV video signals.

58. The HDTV encoder of claim 57 wherein said means for interfacing with said DAC receives a HDTV format data input.

59. The HDTV encoder of claim 57 wherein said means for interfacing with said DAC receives an input selected from the group consisting of a SCART format data input, an NTSC format data input, a PAL format data input, and a SECAM format data input.

60. The HDTV encoder of claim 57 wherein a video level signal selected from the group consisting of a SECAM level signal, a PAL level signal, a SCART level signal, and an NTSC level signal is coupled to said means for interfacing with said DAC.
